(19) United States
(12) Patent Application Publication
(10) Pub. No.: US 2012/0052908 A1
(43) Pub. Date: Mar. 1, 2012

(54) PICO PROJECTOR DEVICE USED WITH MOBILE PHONE

(75) Inventors: Wei Cheng KAO, Taoyuan (TW); Hong Shiang SHEN, Taoyuan (TW); Ching Chen CHANG, Taoyuan (TW)

(73) Assignee: WALSIN LIHWA CORPORATION, Taoyuan (TW)

(21) Appl. No.: 12/872,403

(22) Filed: Aug. 31, 2010

(51) Int. Cl. H04M 1/02

(52) U.S. Cl. 455/557

(57) ABSTRACT

A pico projector device used with a mobile phone is disclosed. The pico projector device used with a mobile phone includes: a housing; a connector, partially exposed from the housing, for connecting with the mobile phone; and a pico projector module, provided in the housing, for projecting an image under control of the mobile phone based on an image signal from the mobile phone through the first connector.

### FIELD OF THE INVENTION

The present invention relates to a pico projector device used with a mobile phone. More particularly, the present invention relates to a pico projector device detachably attached to a mobile phone without a connecting wire.

### BACKGROUND OF THE INVENTION

A mobile phone is an important communication tool in modern life. People use mobile phones to communicate with their friends. Today, mobile phones transmit not only voices, but also images. User's image message can be delivered along with the mobile phone signals and be shown on other phone's screen. In addition, the mobile phone also combines global positioning system (GPS) service, camera module, personal digital assistant (PDA) software, and even wireless television solution. Such powerful functions make the mobile phone industry grow fast in the recent decade.

Since a mobile phone can own a number of functions besides telecommunication, it has another name, smart phone. With the development of new generation smart phones, two key parts become large in size and functionality, the memory and screen. A commonly seen memory has a size of 4 GB to 8 GB. It makes the smart phone store more information for use. For example, photo images taken by the camera module can be temporarily kept in the memory. Downloaded music can be saved for repeated play as well. A large screen, even a touch screen, is able to clearly show an image or a movie to user. However, the size of screen is subject to the size of the smart phone itself. If two people want to review a document stored in the smart phone, it is too crowded if they stand side by side. A fancy invention to solve this problem is a mini projector, also known as pico projector. A mini projecting module can be installed in a smart phone to show an image in the phone onto a larger screen outside. Though the projecting module is so potential that many mobile phone makers plan to embed the module into their products, due to price issue, only few high end smart phones come with pico projectors. It may not be necessary for every smart phone to carry one pico projector module. Applications of pico projector module to a smart phone will be hot spots in the coming future.

On the other hand, although smart phones can provide various services to users, it is still limited to the hardware. When new technology is invented, a new generation smart phone replaces the current one. For example, when a 3.5G smart phone is commercially available, sales volume of 3G or 2G mobile phones are gradually decreased since users eagerly want to own new technology.

From the above, it is obvious that how to link a current phone to a pico projector module to present a desired image is worth study.

Please refer to FIG. 1. It shows a prior art of a micro-projector 1 applied to a portable computer (not shown). The micro-projector 1 includes a projecting device 1a and a clipping structure 1b. The projecting device 1a can communicate with the portable computer via a projection line 1c. The clipping structure 1b is adapted to clipping the portable computer optionally. The projecting device 1a is disposed on the clipping structure 1b. Because the micro-projector 1 clips the portable computer, the space occupied by the micro-projector 1 is relatively small. It is a very simple but useful invention to provide a portable computer with a projecting device. However, a mobile phone is more compact than a portable computer. Clipping structure 1b and projection line 1c are unsuitable for a mobile phone.

FIG. 2 shows another prior art. It is a portable electronic product 2 (mobile phone) with a projecting device 2a. The portable electronic product 2 has a data processing device 2b where a projecting screen 2c is attached. The projecting device 2a is provided at one end of the data processing device 2b. Thereby, images from the projecting device 2a can be projected onto the projecting screen 2c so that more people can see them. However, the projecting screen 2c is inconvenient to carry.

As a result, a modulized pico (mini) projecting device which can be mounted on a mobile phone for projecting images stored in the phone is desperately desired.

### SUMMARY OF THE INVENTION

This paragraph extracts and compiles some features of the present invention; other features will be disclosed in the follow-up paragraphs. It is intended to cover various modifications and similar arrangements included within the spirit and scope of the appended claims.

In accordance with an aspect of the present invention, A pico projector device used with a mobile phone includes: a housing; a connector, partially exposed from the housing, for connecting with the mobile phone; and a pico projector module, provided in the housing, for projecting an image under control of the mobile phone based on an image signal from the mobile phone through the first connector.

Preferably, the pico projector device further includes an adjusting device for adjusting brightness and contrast of the image, and focus and volume of the pico projector module.

Preferably, the adjusting device comprises turning knobs, buttons, or touch pads.

Preferably, the pica projector device further includes a battery set for providing power to the pico projector device.

Preferably, the pico projector module comprises light emitting diodes (LEDs) or laser diodes (LDs) as light sources.

Preferably, the pico projector module is a digital light processing (DLP) module, a liquid crystal on silicon (LCoS) module, or a laser scan module.

Preferably, the connector comprises a mini-universal serial bus (mini-USB) connector, or an external serial advanced technology attachment (E-SATA) connector.

### BRIEF DESCRIPTION OF THE DRAWINGS

FIG. 1 shows a projector device according to a prior art.

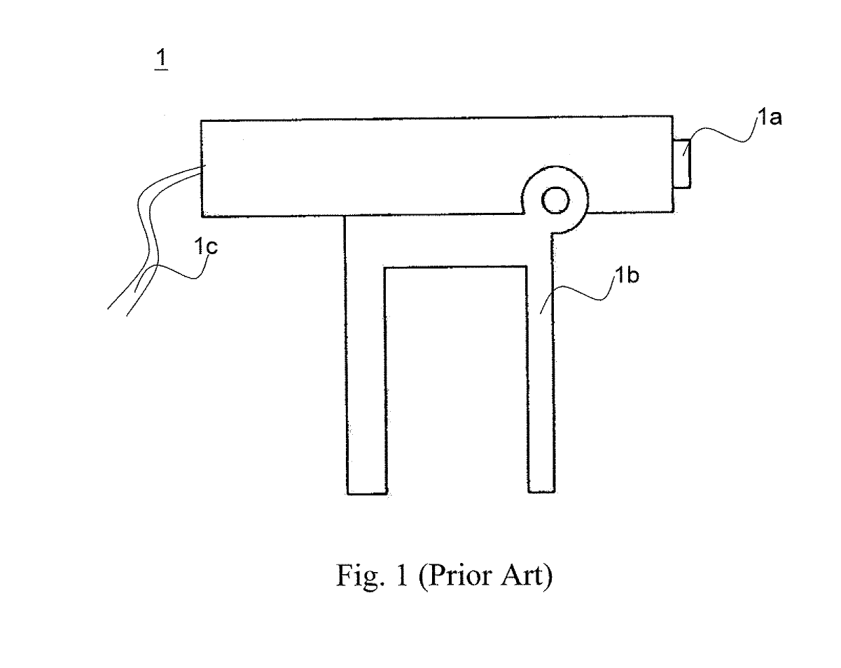

FIG. 2 shows another prior art projector device.

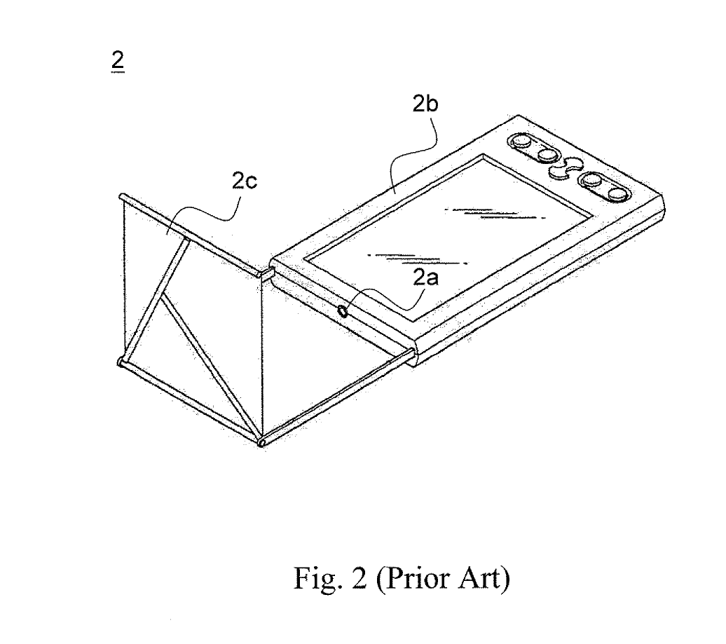

FIG. 3 illustrates a housing of a pico projector device according to a first embodiment of the present invention.

FIG. 4 shows a block diagram of the pico projector device.

FIG. 5 illustrates a pico projector device attached to a mobile phone.

FIG. 6 illustrates a housing of a pico projector device according to a second embodiment of the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illumination and description only; it is not intended to be exhaustive or to be limited to the precise form disclosed.

In order to have a full understanding of the present invention, two embodiments are described below.

### First Embodiment

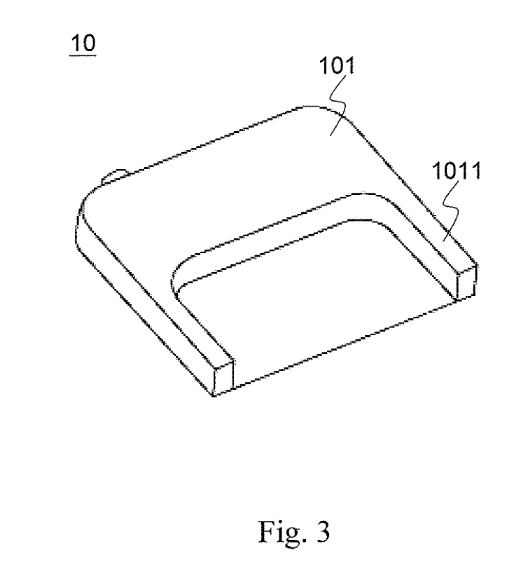

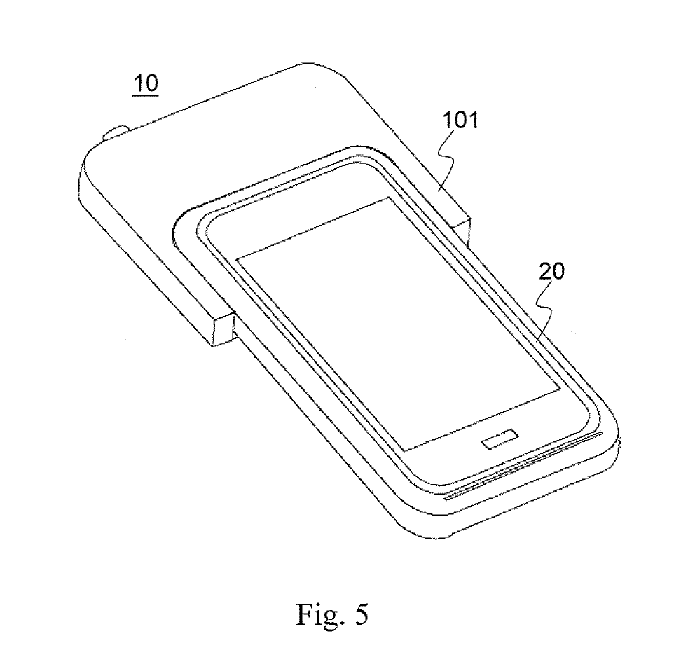

Please refer to FIG. 3 to FIG. 5 illustrating a first embodiment of the present invention. FIG. 3 shows an outer appearance of a pico projector device 10. The pico projector device 10 has a housing 101 to accommodate all elements of the pico projector device 10. The housing 101 has a sleeve structure 1011, as shown in FIG. 3. The sleeve structure 1011 can anchor the housing 101 to a mobile phone 20, as shown in FIG. 5. The housing 101 is made of a plastic material. Of course, metal materials can be used, too. Moreover, the housing 101 can be a combination of metal and plastic.

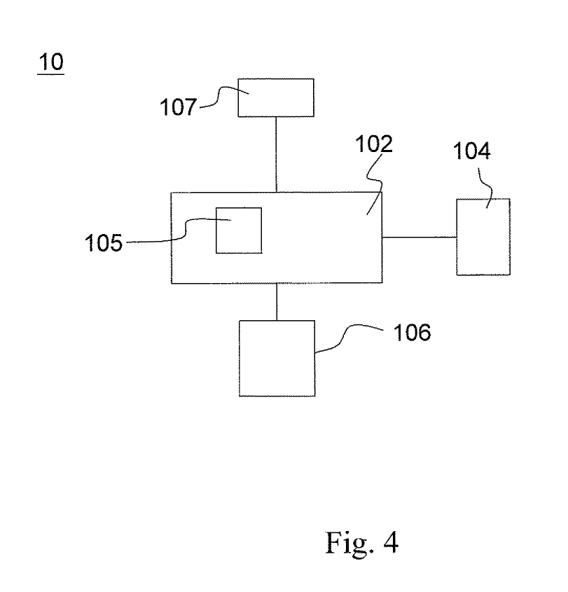

The inner design of the pico projector device 10 is illustrated in FIG. 4. The pica projector device 10 has a connector 104 partially exposed from the housing 101, for connecting with the mobile phone 20. The pica projector device 10 has a pico projector module 102 for projecting an image under control of the mobile phone 20 based on an image signal from the mobile phone 20 through the first connector 104. The pico projector module 102 is a digital light processing (DLP) module. The pico projector module 102 has a light source 105 including a red light, a green light and a blue light (not shown). The light source 105 can be light emitting diodes (LEDs). It should be emphasized that the light source 105 is not limited to LED and laser diode (LD) can also be used. In practice, the pica projector module 102 can also be a liquid crystal on silicon (LCoS) module or a laser scan module. Selection of module depends on requirements.

In this embodiment, the connector 104 is connected with a charging slot of the mobile phone 20, as shown in FIG. 5. Hence, power can be provided to the pico projector device 10 by the mobile phone 20. Alternatively, the pico projector device 10 may have a battery set 106 which can provide power not only to the pico projector device 10 but also to the mobile phone 20 while the pico projector device 10 is off or the mobile phone 20 is at low battery. Furthermore, the pico projector device 10 and the mobile phone 20 may be charged by an external power source or an external charger (not shown) connected to the pica projector device 10. Hence, the pico projector device 10 can be charged by the mobile phone 20, the battery set 106, the external power source, or the external charger.

The connector 104 may be a mini universal serial bus (mini-USB) connector or an external serial advanced technology attachment (E-SATA) connector. Different manufacturers have different connectors for data transmission.

The pico projector device 10 has an adjusting device 107. It is electrically connected to the pico projector module 102 for adjusting brightness and contrast of the image, and focus and volume of the pica projector module 102. The adjusting device 107 has turning knobs, buttons, or touch pads formed on the housing 101. Of course, other adjusting means can also be applied.

FIG. 5 illustrates how the pico projector device 10 is attached to the mobile phone 20. Shape of the housing 101 can be modified to fit different model of mobile phone 20.

### Second Embodiment

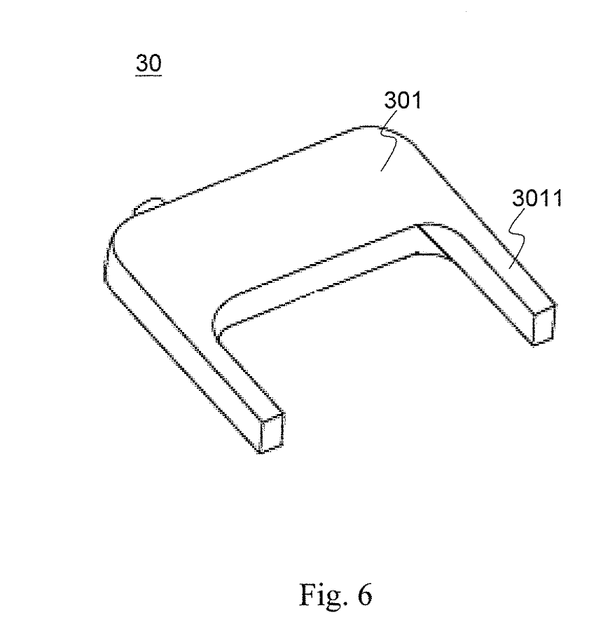

According to the present invention, the sleeve structure 1011 of the housing 101 in the first embodiment can have other forms. Please refer to FIG. 6. A housing 301 of a pico projector device 30 has a pair of arms 3011. They are used to clamp a mobile phone when the pico projector device 30 is connected to the mobile phone.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A pico projector device used with a mobile phone, comprising:
a housing;
a connector, partially exposed from the housing, for connecting with the mobile phone; and
a pico projector module, provided in the housing, for projecting an image under control of the mobile phone based on an image signal from the mobile phone through the first connector.

2. The pico projector device according to claim 1, further comprising an adjusting device for adjusting brightness and contrast of the image, and focus and volume of the pico projector module.

3. The pico projector device according to claim 2, wherein the adjusting device comprises turning knobs, buttons, or touch pads.

4. The pico projector device according to claim 1, further comprising a battery set for providing power to the pico projector device.

5. The pico projector device according to claim 1, wherein the pica projector module comprises light emitting diodes (LEDs) or laser diodes (LDs) as light sources.

6. The pico projector device according to claim 1, wherein the pico projector module is a digital light processing (DLP) module, a liquid crystal on silicon (LCoS) module, or a laser scan module.

7. The pica projector device according to claim 1, wherein the connector comprises a mini-universal serial bus (mini-USB) connector, or an external serial advanced technology attachment (E-SATA) connector.
